(19) United States
(12) Patent Application Publication
(10) Pub. No.: US 2005/0083276 A1
(43) Pub. Date: Apr. 21, 2005

(54) Light-emitting device underneath display panel of multimedia mobile phone

(76) Inventors: Hsi-Che Lee, Taipei (TW); Tung-Hsing Pan, Taipei (TW); Mei-Jiuan Chen, Taipei (TW)

Correspondence Address: BIRCH STEWART KOLASCH & BIRCH, PO BOX 747, FALLS CHURCH, VA, 22040-0747, US

(21) Appl. No.: 10/685,426

(22) Filed: Oct. 16, 2003

(51) Int. Cl. G09G 3/32

(52) U.S. Cl. 345/83

(57) ABSTRACT

A light-emitting device underneath display panel of multimedia mobile phone mainly comprises a CPU, a memory, a timepiece, a communication interface, a keypad, a connector and a LED drive circuit installed inside of a mobile phone. The connector can be connected to a computer, a PDA or a digital camera enabling images to be transmitted to the CPU and stored in the memory through computer programming. In addition, displayed image time and order can be manually configured by the computer programming. Therefore, the invention enables the full-color screen to show images according to display time and display order preset, moreover, enables the light-emitting device to be illuminated or off according to the image display in order to save the mobile phone electricity.

### FIELD OF THE INVENTION

The present invention relates to a light-emitting device (LED) on display panel of multimedia cellular phone, and more particularly, to a light-emitting device that is installed underneath the display panel of a mobile phone, in addition, the invention enables the full-color screen of the mobile phone to show images according to the configuration of computer programs, moreover, enables the light-emitting device to be illuminated or off according to the image display in order to effectively save the mobile phone electricity.

### BACKGROUND OF THE INVENTION

Mobile phones have become the most convenient communication tool everywhere at the present time. Excepting for communications, mobile phones are also the most popular commodities to young generation. Therefore, mobile phone manufacturers have tried with all their strength to promote various styles of mobile phone goods to attract young consumers.

Generally, display panel of a mobile phone not only displays messages, but also displays graphs or images, however, most of the graphs or images are pre-set on the mobile phone, those fixed unchanged graphs or images can not be self-altered by users, so as to bore users easily.

Some mobile phones on the market comprise the functions of drawing and animation, enabling mobile phone users to draw lovely graphs by themselves and to consecutively display many graphs to generate animation effect; in addition, some mobile phones contain the album function to display photos. However, the animation functions provided on those mobile phones are unable to be smoothly utilized as on computer, the animation effects generated by those mobile phones remain to be improved.

What is more, display panels of mobile phones of prior arts are all monochromes failing to display in full-color, in spite that newly innovated mobile phones are equipped with full-color screens each, it is electricity-consumed when a mobile phone is power-on waiting for the entire luminance of the full-color screen. In addition, full-color screens of general mobile phones are not brightened but dimmed for users to see in standby state; the full-color screen of a mobile phone is only completely brightened up when the mobile phone is being used. Consequently, such mobile phones cannot completely display the full-color function, especially when the mobile phone is placed on the table for standby, as the full-color screen of the mobile phone is dimmed without the full-color effect whereon.

### SUMMARY OF THE INVENTION

In view of the drawbacks of aforementioned display panel of a mobile phone of prior art, a light-emitting device (LED) on display panel of multimedia cellular phone with the functions of multimedia display or digital album mainly comprising a CPU, a memory, a timepiece, a communication interface, a keypad, a connector and a LED drive circuit installed inside of a mobile phone. The CPU is connected to the memory, the timepiece, the communication interface and the LED drive circuit. In addition, the communication interface is connected to the keypad and the connector, moreover, the LED drive circuit is connected to a light-emitting device. According to the preceding structure, the connector can be connected to a computer, a PDA or a digital camera enabling images from the computer, the PDA or the digital camera to be transmitted to the CPU and stored in the memory through computer programming. In addition, displayed image time can be manually configured by the computer programming. Moreover, the invention enables the full-color screen of the mobile phone to show images according to the configuration of computer programs, moreover, enables the light-emitting device to be illuminated or off according to the image display in order to effectively save the mobile phone electricity.

Therefore, the main objective of the invention is to provide a light-emitting device underneath display panel of multimedia mobile phone. In addition, the invention enables the full-color screen of the mobile phone to show images according to the configuration of computer programs, moreover, enables the light-emitting device to be illuminated or off according to the image display in order to effectively save the mobile phone electricity.

### BRIEF DESCRIPTION OF THE DRAWINGS

FIG. 1 is a circuit block diagram of the invention;

FIG. 2 is a file-creating programming flowchart of the invention;

FIG. 3 is a play programming flowchart of the invention;

FIG. 4A is a play time coordination of the invention; and FIG. 4B

FIG. 5 is a circuit block diagram of another preferred embodiment according to the invention.

### DETAILED DESCRIPTION OF THE PREFERRED EMBODIMENTS

The present invention can be more fully understood by reading the following detailed description of a preferred embodiment, with reference made to the accompanying drawings, wherein:

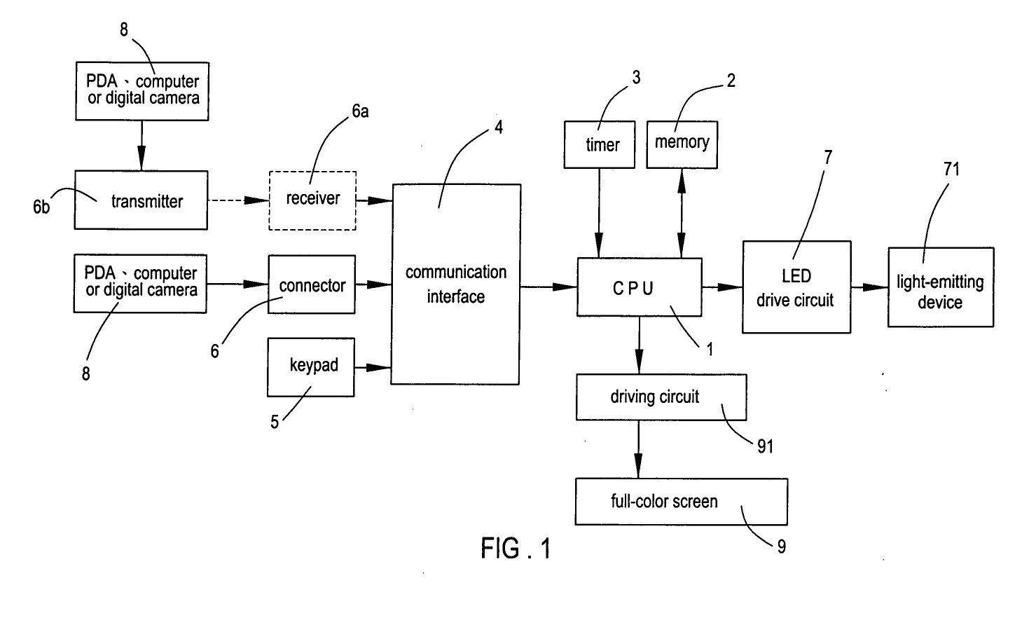

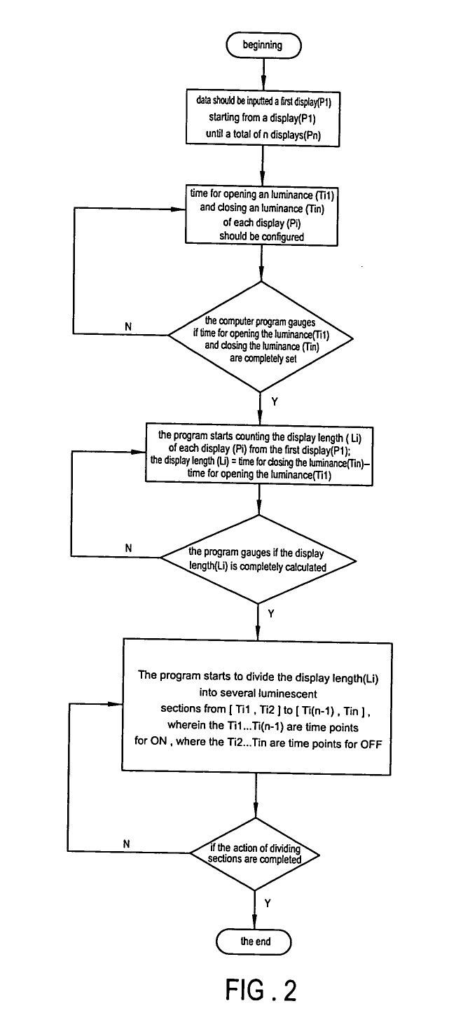

First of all, referring to FIG. 1 and FIG. 2 that the invention mainly comprises a CPU 1, a memory 2, a timepiece 3, a communication interface 4, a keypad 5, a connector 6 and a LED drive circuit 7 installed inside of a mobile phone (not shown). The functions of and connections between respective components are depicted as follows,
the CPU 1 is installed inside the mobile phone for controlling internal circuits;
The memory 2 is connected to the CPU 1 for storing image files;
the timepiece 3 is connected to the CPU 1 for counting time to be outputted to the CPU 1 enabling the CPU 1 to retrieve files with time;
the communication interface 4 is connected to the CPU 1 for transmitting inputted signals;
The keypad 5 is connected to the communication interface 4 for inputting control signals.

The connector 6 is connected to the communication interface 4 for connecting to a computer, a PDA or a digital camera 8, so that images can be transmitted to the CPU 1, which can transmit images to full-color screen 9 of a mobile phone through a driving circuit 91 that drives the screen 9;
The LED drive circuit 7 is connected to the CPU 1 and a light-emitting device 71 that is installed underneath a full-color screen 9 of the mobile phone enabling the light-emitting device 71 to be illuminated or off tied in with images.

According to the preceding structure, the connector 6 on the mobile phone can be connected to a computer, a PDA or the digital camera 8 enabling images from the computer, the PDA or the digital camera 8 to be transmitted to the communication interface 4, subsequently to the CPU 1 and stored in the memory 2 through the control of the CPU 1. Consequently, image files can be retrieved from the memory 2 through the programming control of the CPU 1 to be displayed on the full-color screen 9 of the mobile phone, so that the full-color screen 9 on the mobile phone can display various images by the computer programming to attract young generation of consumers.

To achieve the auto-display effect on the mobile phone, a user must complete the image compilations on a computer, a PDA or the digital camera 8, and then determine the sequence and timing of each image, finally transmit the images and relevant configured data to the memory 2. Consequently, when the mobile phone is power-on the user can play the images in order or at fixed time according to controlled signals. To save electricity, each display on the mobile phone is not completely illuminated; instead, the mobile phone user can decide each image display by phases. Thus, the invention enables the screen of the mobile phone to be distinct and clear when the light-emitting device 71 is brightened and sometimes enables the light-emitting device 71 is off in order to save electricity.

Graphic data needs to be controlled by a file-creating program when being inputted into a computer, a PDA or the digital camera 8. The configuration flowchart of the file-creating program is shown on FIG. 2 that data should be inputted a first display (P1) starting from a display (P1) until a total of n displays (Pn). Subsequently, time for opening an luminance (Ti1) and closing an luminance (Tin) of each display (Pi) should be configured, and then the computer program gauges if time for opening the luminance (Ti1) and closing the luminance (Tin) are completely set. If not, the mobile phone re-sets time for opening an luminance (Ti1) and closing an luminance (Tin); otherwise, the program starts counting the display length (Li) of each display (Pi) from the first display (P1). The display length (Li)=time for closing the luminance (Tin)—time for opening the luminance (Ti1). Consequently, the program gauges if the display length (Li) is completely calculated; if not, the program re-calculates the display length (Li); otherwise the program enters into the step of dividing the display length (Li) from the first display (P1). The program starts to divide the display length (Li) into several luminescent sections from [Ti1, Ti2] to [Ti(n−1), Tin], wherein the Ti1 . . . Ti(n−1) are time points for ON, where the Ti2 . . . Tin are time points for OFF. Subsequently, the program gauges if the action of dividing sections are completed; if not, the program re-divides the display length (Li); otherwise, the file-creating program is ended herein.

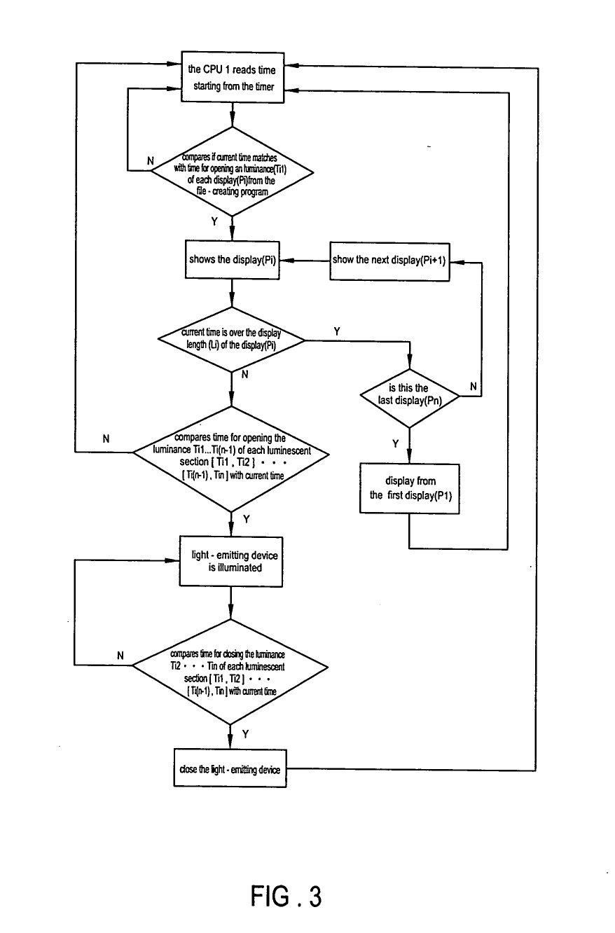

The flowchart of the play programming is as shown on FIG. 3 that the CPU 1 reads time starting from the timepiece 3, and then compares if current time matches with time for opening an luminance (Ti1) of each display (Pi) from the file-creating program. If current time differs from time for opening the luminance (Ti1) of the display (Pi), the CPU 1 continuously reads time from the timepiece 3 to be compared with time for opening the luminance (Ti1); otherwise, if current time the CPU 1 reads from the timepiece 3 is the same as time for opening the luminance (Ti1) of the display (Pi), the CPU 1 reads image data from the memory 2 and shows the display (Pi), and then the program compares the display length (Li) of the display (Pi) according to current time. If current time is over the display length (Li) of the display (Pi) the program re-gauges if the display (Pi) is the last display (Pn). If yes, the program re-reads current time and restarts; otherwise the program changes to the next display (Pi+1). Subsequently, the program compares time for opening the luminance Ti1 . . . Ti(n−1) of each luminescent section [Ti1, Ti2] . . . [Ti(n−1), Tin] with current time. If both time points are the same, the light-emitting device 71 is lightened; otherwise the program re-reads a current time. When the current time is the same as time for closing the luminance Ti2 . . . Tin of each luminescent section [Ti1, Ti2] . . . [Ti(n−1), Tin], the light-emitting device 71 is switched off. When the current time differs, the light-emitting device 71 is continuously lightened, thereby each display (Pi) can be illuminated in different phases or non-luminous.

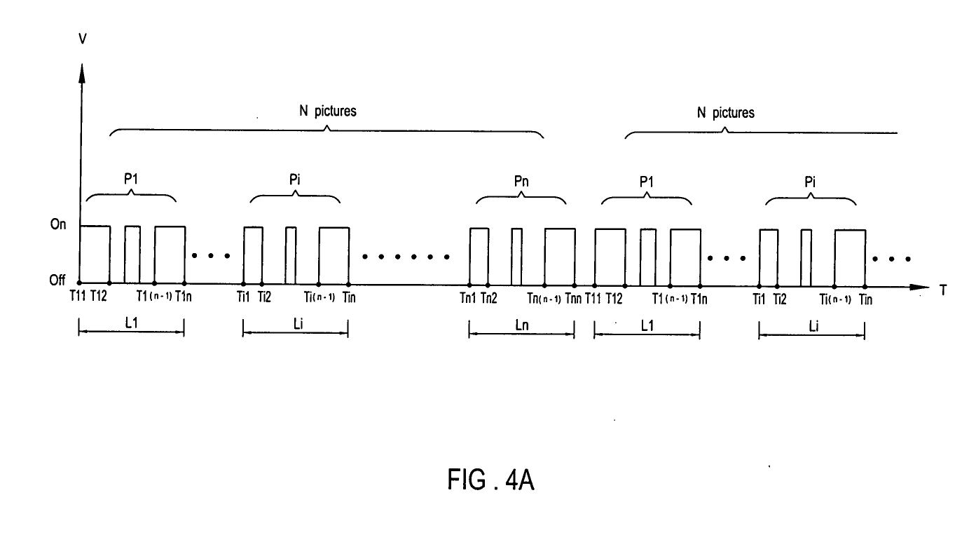

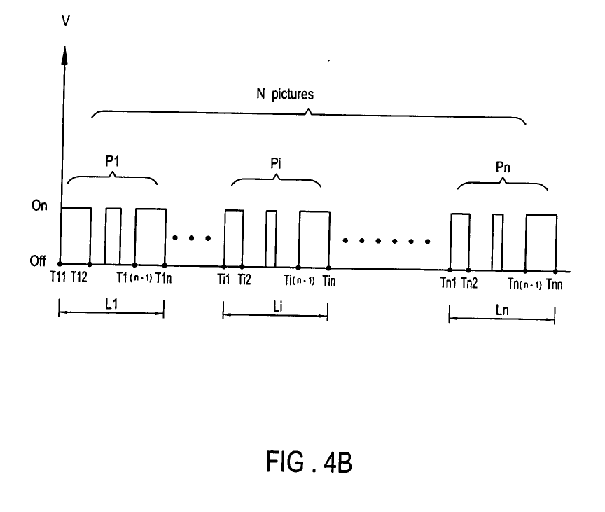

In summary, as shown on FIG. 4A, the total number of the displays and the time of each display can be set according to the needs of users and then circulate all day. By the way, users also can only set the display time of a series of displays (from P1 to Pn) and just display the specific displays, as shown in FIG. 4B, at specific time. The light-emitting device 71 can be illuminated in phases or off tied in with an image of each display (Pi), so as to save energy of the mobile phone.

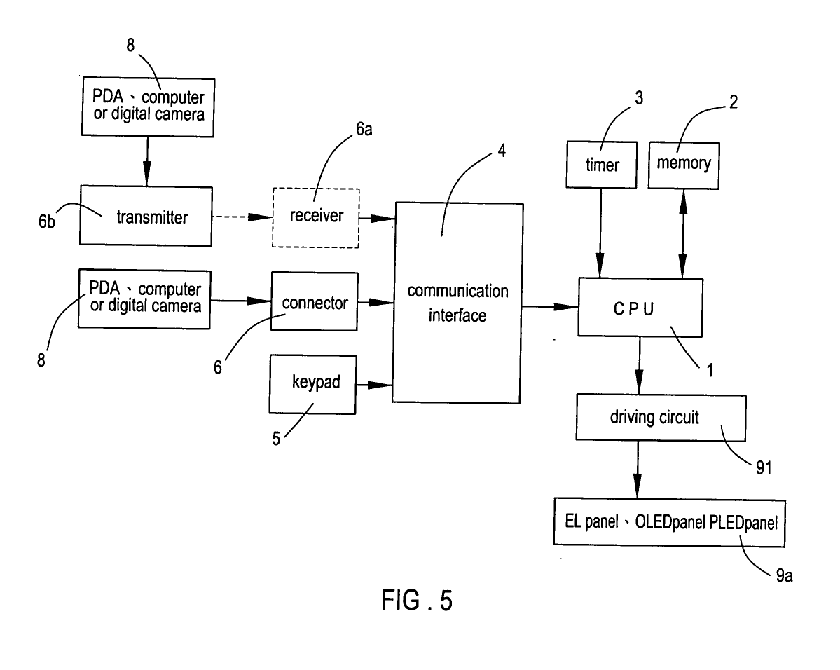

Moreover, the light-emitting device 71 can be designed either a back type or a front type; the full-color screen 9 of the mobile phone can be designed to be a self-illuminated EL panel, a OLED panel or a PLED panel, enabling the CPU to transmit images to the EL panel, the OLED panel or the PLED panel and to display the images. As shown on FIG. 5, the CPU 1 is able to transmit images to the EL panel, the OLED panel or the PLED panel 9a and to display the images, so that the LED drive circuit 7 and the light-emitting device 71 can be left out. This is another embodiment of the invention for reference.

With reference to FIG. 1, the connector 6 can be designed as per requirements to be a receiver 6a, in addition, the receiver 6a can receive a wireless signal from a transmitter 6b that is connected to a computer, a PDA or the digital camera 8. This is another embodiment of the invention.

In conclusion from the above, the disclosed structure of the invention is new design separating from prior arts. The present invention is, therefore, disclosed herein for its practicability and advancement.

1. A light-emitting device underneath display panel of multimedia mobile phone, comprising,
a CPU, installed inside a mobile phone for controlling internal circuits;
a memory, connected to the CPU for storing image files;
a timepiece, connected to the CPU for counting time to be outputted to the CPU enabling the CPU to retrieve files with time;
a communication interface, connected to the CPU for transmitting inputted signals;
a keypad, connected to the communication interface for inputting control signals;
a connector, connected to the communication interface for connecting to a computer, a PDA or a digital camera, which can transmit images to the CPU, so as to enable the CPU to transmit images to full-color screen of a mobile phone through a driving circuit that drives the display;
a LED drive circuit, connected to the CPU and a light-emitting device that is installed underneath a full-color screen of the mobile phone enabling the light-emitting device to be illuminated or off tied in with images.

2. The light-emitting device underneath display panel of multimedia mobile phone of claim 1, wherein the light-emitting device can be designed either a back type or a front type.

3. The light-emitting device underneath display panel of multimedia mobile phone of claim 1, wherein the full-color screen of the mobile phone can be designed to be a self-illuminated EL panel, a OLED panel or a PLED panel, enabling the CPU to transmit images to the EL panel, the OLED panel or the PLED panel and to display the images.

4. The light-emitting device underneath display panel of multimedia mobile phone of claim 1, wherein the connector can be designed to be a receiver as per requirements, in addition, the receiver can receive a wireless signal from a transmitter, which is connected to the computer, the PDA or the digital camera.
